(19) United States
(12) Patent Application Publication
(10) Pub. No.: US 2017/0278185 A1
(43) Pub. Date: Sep. 28, 2017

(54) SYSTEM AND METHOD FOR A CREDIT SUMMARY REPORT AND SCORE BASED ON FINANCIAL DATA PROVIDED BY A FINANCIAL INSTITUTION

(71) Applicant: Arthur Vick Veal, IV, South Holland, IL (US)

(72) Inventor: Arthur Vick Veal, IV, South Holland, IL (US)

(21) Appl. No.: 15/076,725

(22) Filed: Mar. 22, 2016

(51) Int. Cl. G06Q 40/02; G06Q 20/02

(52) U.S. Cl. CPC G06Q 40/025; G06Q 20/023

(57) ABSTRACT

An apparatus, system and method for determining credit worthiness based on the collection of transactional data corresponding to banking transactions associated with a customer; generating a financial history based on the transactional data, and determining credit worthiness based thereon.

### BACKGROUND OF THE INVENTION

The credit worthiness of a potential purchaser may be determined by the person's credit score. The credit score is a number based on a statistical analysis of the person's credit files and in theory represents the likelihood that the person will pay his or her bills. Credit scores are often based on credit report information from the three major credit bureaus: Experian, TransUnion, and Equifax. Income is not considered by the major credit bureaus. Credit scores may be calculated using different methods. The most well-known and widely used type of credit score is FICO developed by Fair Isaac Corporation. FICO credit scores ranges between 300 and 850. A lower credit score indicates a greater risk that the borrower may default on his or her financial obligations to the lender. A higher credit score means there is less risk that the borrower will default. Each of the major credit bureaus has its own credit scores. A credit report consists of the relevant payment history from accounts that report to the 3 major credit bureaus. The report does not include any income or payment information from a person's bank account.

Currently, financial institution transactional data is not utilized in determining credit worthiness. For example, personal income summaries and bill payment information is not summarized from a customer's banking data. Such information would be useful in gauging the person's current credit worthiness and their ability to make future payments. All of the currently employed scoring systems use a fixed scoring methodology which does not take into account current transactions data which may provide additional insight into the credit worthiness of a customer.

Therefore, a need exists for an improved method and system of determining the credit worthiness of potential customers.

It is an object of the invention to provide an alternative means for determining the credit worthiness of an individual based on their banking history.

### SUMMARY OF THE INVENTION

The above and other objects are met by the present invention, one embodiment of which relates to a method and system for determining credit worthiness based on an individual's banking history.

These and other features, aspects and advantages of the present invention will become better understood with reference to the following drawings, description and claims.

### BRIEF DESCRIPTION OF THE DRAWINGS

FIG. 1 is a flow chart of the invention.

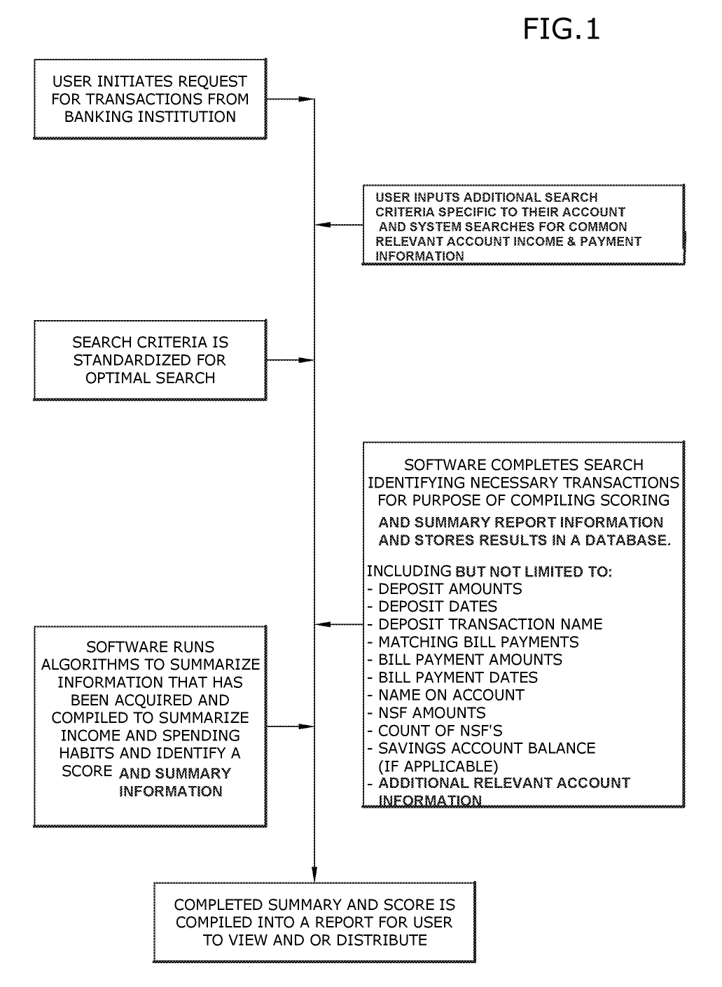

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

One embodiment of the invention relates to an apparatus comprising: a computer, the computer comprising a memory and a processor, where the processor executes computer-executable instructions in the memory to perform a method of: receiving transactional data corresponding to banking transactions associated with a customer; generating a financial history based on the transactional data, and determining credit worthiness based on the financial history.

A further embodiment of the invention comprises a system comprising: a computer, the computer comprising a memory and a processor, wherein the processor executes computer-executable instructions in the memory for: receiving transactional data corresponding to banking transactions associated with a customer; generating a financial history based on the banking data, and determining credit worthiness based on the financial history.

A still further embodiment of the invention concerns a method of determining credit worthiness of a customer, the method comprising: receiving transactional data corresponding to banking transactions associated with the customer; calculating a financial history using the transactional data, and determining credit worthiness based on the financial history.

An additional embodiment of the invention comprises a computer-readable medium storing computer-executable instructions configured to cause a processor storing and to perform a method comprising: generating a financial history based on transactional data corresponding to banking transactions associated with a customer, and determining credit worthiness based on the financial history.

The crux of the invention resides in an algorithm that summarizes a person's financial history for the purpose of determining credit worthiness using information obtained from banking transactions. By utilizing bank transactions the information is available in real time, with less chance of error and is easily verifiable. Also, by utilizing financial information directly from the source a more accurate picture of a person's credit worthiness can be described.

It will be understood by those skilled in the art that the invention contemplates the compilation of data from all banking transactions, including but not limited to, deposits, withdrawals, credit and debit card transactions, wire transfers, online bill payments, mortgage loans and small business loans.

Referring to the drawing, a preferred embodiment of the invention comprises the following steps/elements:
1. User initiates request for banking transactions;
2. User enters required search criteria (i.e., payee's names);
3. Search criteria is standardized for optimal searching;
4. Algorithm searches transactions for relevant transaction information;
5. Algorithms run to summarize transaction information;
6. Algorithm scores summary of information to provide a financial history

More particularly, the various embodiments of the invention involve:
a user initiating a request for transactions from a person's banking institution;
the user inputting additional search criteria specific to an account and the system searching for common relevant account income & payment information;
standardization by the system of the search criteria to optimize the search;
the system completes the search, identifying necessary transactions for purpose of compiling scoring information and puts relevant information into a data base, the information including, but not limited to deposit amounts, deposit dates, deposit transaction name, matching bill payments, bill payment amounts, bill payment dates, the name on the account, nsf amounts, count of nsf's, savings account balance, and the like;
the system runs the algorithms to summarize information that has been acquired and compiled to summarize income and spending habits and identify credit worthiness in relation to total baseline of users;
the system completes the summary and a financial history is compiled into a report for viewing and distribution.

The above steps/elements run individually to take the raw data of all bank transactions and remove unnecessary data to then run calculations on the remaining data after which the calculation data is used to create a credit profile which can then be scored against a weighted model of a perfect score to determine credit worthiness for that individual set of data. The data from each step must be passed to the next step in the proper format to ensure all calculations are performed correctly and at optimal speed.

The preferred algorithms of element/step 5, where calculations against the data are created, are proprietary. Those skilled in the art will appreciate that any suitable algorithm may be employed in the practice of the invention. Based on this logic, calculations will only run if certain variables exist. If those variables do not exist then the calculation may be deemed unnecessary and therefore will not run. The algorithm(s) of the invention which pulls financial data, processes the financial data, and then outputs a summary based on the financial information provided.

It should be understood, of course, that the foregoing relates to exemplary embodiments of the invention and that modifications may be made without departing from the spirit and scope of the invention as set forth in the following claims.

What is claimed is:

1. An apparatus comprising: a computer, the computer comprising a memory and a processor, where the processor executes computer-executable instructions in the memory to perform a method of: receiving financial data corresponding to banking transactions associated with a customer; generating a financial history based on the transactional data, and determining credit worthiness based thereon.

2. The apparatus of claim 1, wherein the transactional data comprises debit transactions, credit transactions, and deposit transactions.

3. The apparatus of claim 1, wherein the transactional data comprises electronic bill and/or Automated Clearing House (ACH) payment transactions.

4. The apparatus of claim 1, wherein the transactional data comprises checking and saving and credit account transactions, and interest deposit transaction.

5. A system comprising: a computer, the computer comprising a memory and a processor, wherein the processor executes computer-executable instructions in the memory for: receiving transactional data corresponding to banking transactions associated with a customer; generating a financial history based on the transactional data, and determining credit worthiness based thereon.

6. A method of determining credit worthiness of a customer, the method comprising: receiving transactional data corresponding to banking transactions associated with the customer; calculating a financial history using the transactional data, and determining credit worthiness based thereon.

7. A computer-readable medium storing computer-executable instructions configured to cause a processor storing and to perform a method comprising: generating a financial history based on transactional data corresponding to banking transactions associated with a customer, and determining credit worthiness based thereon.
